(19) United States
(12) Patent Application Publication
(10) Pub. No.: US 2008/0180511 A1
(43) Pub. Date: Jul. 31, 2008

(54) THERMAL HEAD DRIVING CIRCUIT

(76) Inventors: Tomomitsu Oohara, Kanagawa (JP); Yukihiro Terada, Kanagawa (JP)

Correspondence Address: LADAS & PARRY LLP, 224 SOUTH MICHIGAN AVENUE, SUITE 1600, CHICAGO, IL, 60604, US

(21) Appl. No.: 11/968,261

(22) Filed: Jan. 2, 2008

(30) Foreign Application Priority Data
Jan. 31, 2007 (JP) 2007-022198

(51) Int. Cl. B41J 2/35

(52) U.S. Cl. 347/211

(57) ABSTRACT

A disclosed thermal head driving circuit includes an inverter type drive circuit including a p-channel MOS transistor and a first n-channel MOS transistor, and configured to have a driving signal of a rectangular wave provided at gates of the p-channel MOS transistor and the first n-channel MOS transistor to invert the driving signal; a power MOS transistor configured to have provided, at its gate, the inverted drive signal output from the inverter type drive circuit to drive a thermal head connected to its drain; a first resistance connected between a drain of the p-channel MOS transistor and a drain of the first n-channel MOS transistor; and a second resistance connected between a junction point between the first resistance and the drain of the first n-channel MOS transistor, and the gate of the power MOS transistor.

### BACKGROUND OF THE INVENTION

1. Field of the Invention

The present invention relates generally to thermal head driving circuits, and more particularly to a thermal head driving circuit including an inverter type drive circuit and a power MOS transistor.

2. Description of the Related Art

There is a conventional printing method as follows. Thermal heads, which generate heat when an electrical current is applied, are arranged in a line. An electrical current is applied to each thermal head from a driving circuit provided for each thermal head. Accordingly, the ink on thermal paper is thermally dissolved, so that printing is performed.

FIG. 7 is an example of a circuit diagram of the conventional thermal head driving circuit. This circuit is formed into a semiconductor integrated circuit, and the portion for driving one of the thermal heads is illustrated in FIG. 7.

In FIG. 7, a one-bit driving signal (rectangular wave) is supplied to a terminal 1, which is then supplied to the gate of a p-channel MOS-FET (field-effect transistor) QP1 and an n-channel MOS-FET QN1. The source of the FET QP1 is connected to a power source Vdd, the drains of the FET QP1 and the FET QN1 are in common connection with respect to each other, the source of the FET QN1 is connected to ground, and the FET QP1 and the FET QN1 form an inverter type drive circuit.

The gate of an n-channel FET QN2, which is a power MOS transistor, is connected to the drains of the FET QP1 and the FET QN1. The FET QN2 has its source connected to the ground and its drain connected to an external terminal 2 of the semiconductor integrated circuit. A capacitor Cin provides a parasitic capacitance between the gate and the source of the FET QN2. One end of a thermal head 3 is connected to the external terminal 2, and the other end of the thermal head 3 is connected to the power source Vdd.

Patent Document 1 discloses a circuit for delaying the rise and decay of the rectangular wave.

Patent Document 1: Japanese Laid-Open Patent Application No. H4-87373

Conventionally, when a driving signal of a rectangular wave is supplied to the terminal 1, as shown with the solid line in FIG. 4, the output voltage of FET QN2 becomes a wave form including switching noises at the time of the rise and at the time of the decay. If the maximum value of the switching noise exceeds the withstand voltage of the semiconductor integrated circuit, the semiconductor integrated circuit will break.

### SUMMARY OF THE INVENTION

The present invention provides a thermal head driving circuit in which one or more of the above-described disadvantages are eliminated.

A preferred embodiment of the present invention provides a thermal head driving circuit capable of reducing switching noises and preventing the semiconductor integrated circuit from breaking.

An embodiment of the present invention provides a thermal head driving circuit including an inverter type drive circuit including a p-channel MOS transistor and a first n-channel MOS transistor, and configured to have a driving signal of a rectangular wave provided at gates of the p-channel MOS transistor and the first n-channel MOS transistor to invert the driving signal; a power MOS transistor configured to have provided, at its gate, the inverted drive signal output from the inverter type drive circuit to drive a thermal head connected to its drain; a first resistance connected between a drain of the p-channel MOS transistor and a drain of the first n-channel MOS transistor; and a second resistance connected between a junction point between the first resistance and the drain of the first n-channel MOS transistor, and the gate of the power MOS transistor.

An embodiment of the present invention provides a thermal head driving circuit including an inverter type drive circuit including a first p-channel MOS transistor and an n-channel MOS transistor, and configured to have a driving signal of a rectangular wave provided at gates of the first p-channel MOS transistor and the n-channel MOS transistor to invert the driving signal; a power MOS transistor configured to have provided, at its gate, the inverted drive signal output from the inverter type drive circuit to drive a thermal head connected to its drain; a first resistance connected between a drain of the first p-channel MOS transistor and a drain of the n-channel MOS transistor; and a second resistance connected between a junction point between the first resistance and the drain of the first p-channel MOS transistor, and the gate of the power MOS transistor.

According to one embodiment of the present invention, the rise and the decay of a driving signal can be dampened to the same extent so that switching noise is reduced and the semiconductor integrated circuit is prevented from breaking.

### BRIEF DESCRIPTION OF THE DRAWINGS

Other objects, features and advantages of the present invention will become more apparent from the following detailed description when read in conjunction with the accompanying drawings, in which:

FIG. 1 is a circuit diagram of a thermal head driving circuit according to an embodiment of the present invention;

FIGS. 2A and 2B are waveform diagrams of a driving signal and the gate voltage of a power MOS transistor;

FIG. 3 is a graph for describing the present invention;

FIG. 4 illustrates the output voltage waveform of the power MOS transistor;

FIG. 5 is a circuit diagram of a modification of the thermal head driving circuit according to the embodiment of the present invention;

FIG. 6 is a circuit diagram of a thermal head driving circuit according to another embodiment of the present invention; and

FIG. 7 is a circuit diagram of a conventional thermal head driving circuit.

### DETAILED DESCRIPTION OF THE PREFERRED EMBODIMENTS

A description is given, with reference to the accompanying drawings, of an embodiment of the present invention.

### Embodiment of Thermal Head Driving Circuit

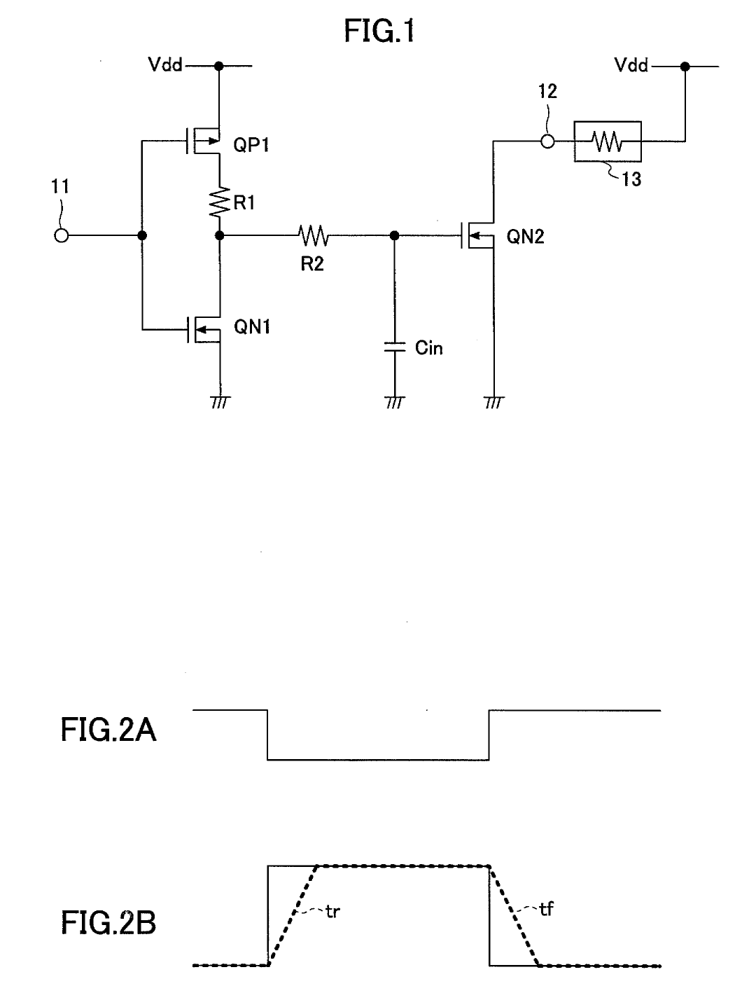

FIG. 1 is a circuit diagram of a thermal head driving circuit according to an embodiment of the present invention. This circuit is formed as a semiconductor integrated circuit, and the portion for driving one of the thermal heads is illustrated in FIG. 1. There are several tens through several hundreds of thermal heads arranged in a line, and each thermal head is provided with the driving circuit shown in FIG. 1. The semiconductor integrated circuit includes plural driving circuits shown in FIG. 1 equivalent to the number of thermal heads.

As shown in FIG. 1, a one-bit driving signal (rectangular wave) is supplied to a terminal 11, which is then supplied to the gate of a p-channel MOS-FET QP1 and the gate of an n-channel MOS-FET QN1. The source of the FET QP1 is connected to a power source Vdd, the drain of the FET QP1 is connected to the drain of the FET QN1 via a resistance R1, the source of the FET QN1 is connected to ground, and the FET QP1 and the FET QN1 form an inverter type drive circuit.

The junction point of the resistance R1 and the drain of the FET QN1 is connected, via a resistance R2, to the gate of an n-channel FET QN2, which is a power MOS transistor. The FET QN2 has its source connected to ground and its drain connected to an external terminal 12 of the semiconductor integrated circuit.

A capacitor Cin provides a parasitic capacitance between the gate and the source of the FET QN2. One end of a thermal head 13 is connected to the external terminal 12, and the other end of the thermal head 13 is connected to the power source Vdd.

The electrical charge time constant of the capacitor Cin is determined by the capacitor Cin, which provides a parasitic capacitance between the gate and the source of the FET QN2, and the resistances R1 and R2, and the electrical discharge time constant of the capacitor Cin is determined by the capacitor Cin and the resistance R2.

As shown in FIG. 2A, when the driving signal supplied to the terminal 11 decays, the FET QP1 switches on and the FET QN1 switches off, and as shown with the dashed line in FIG. 2B, the gate voltage of the FET QN2 rises with a slope tr, and the FET QN2 switches on. Accordingly, an electric current is applied to the thermal head 13, and the thermal head 13 generates heat.

Furthermore, when the driving signal rises, the FET QP1 switches off and the FET QN1 switches on, and as shown with the dashed line in FIG. 2B, the gate voltage of the FET QN2 decays with a slope tf, and the FET QN2 switches off. Accordingly, the electric current is prevented from being applied to the thermal head 13.

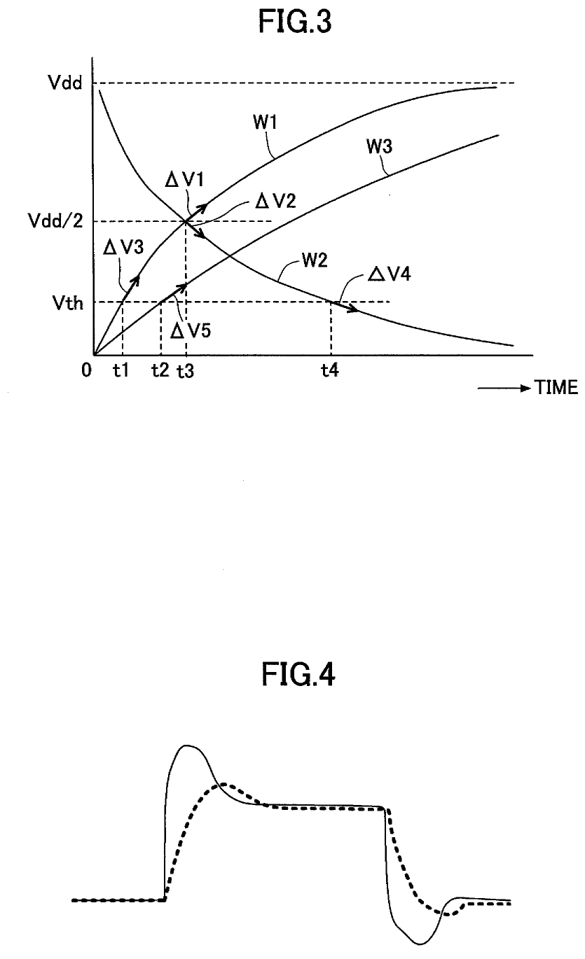

The FET QN2, which is a power MOS transistor, switches on/off at a threshold voltage Vth. If the threshold voltage Vth is Vdd/2, ΔV1/T=ΔV2/T will be satisfied, where ΔV1 is the slope of a charge waveform W1 shown in FIG. 3 at a time t3 at which the charge waveform W1 reaches Vdd/2, ΔV2 is the slope of a discharge waveform W2 at the time t3 at which the discharge waveform W2 reaches Vdd/2, and T is the time. That is, the time constants of the rise and the decay will be the same.

However, the threshold voltage Vth of an n-channel FET QN2 is usually around 1 V, which satisfies ΔV3/T≠ΔV4/T, where ΔV3 is the slope of the charge waveform W1 at a time t1 at which the charge waveform W1 reaches the threshold voltage Vth (=1 V), and ΔV4 is the slope of the discharge waveform W2 at a time t4 at which the discharge waveform W2 reaches the threshold voltage Vth. This means that unless the time constants of the rise and the decay are different, it is not possible to make the time from when the driving signal rises until when the power MOS transistor switches on (corresponding to the slope tr in FIG. 2B) be equivalent to the time from when the driving signal decays until when the power MOS transistor switches off (corresponding to the slope tf in FIG. 2B).

To make the aforementioned times be equivalent to each other, a charge waveform W3 is determined by setting the resistances R1 and R2 in such a manner as to satisfy ΔV5/T=ΔV4/T, where ΔV5 is the slope of the charge waveform W3 at a time t2 at which the charge waveform W3 reaches the threshold voltage Vth. Accordingly, the electrical charge time constant of the capacitor Cin is determined by the capacitor Cin, which provides a parasitic capacitance between the gate and the source of the FET QN2, and the resistances R1 and R2, and the electrical discharge time constant of the capacitor Cin is determined by the capacitor Cin and the resistance R2.

With a simple configuration of additionally providing the resistances R1 and R2, the rise and the decay of the driving signal can be dampened to the same extent. As a result, the output voltage waveform graph of the FET QN2 will become the dashed line in FIG. 4, in which the switching noise at the times of the rise and the decay are reduced.

Accordingly, it is possible to prevent the semiconductor integrated circuit from breaking.

### Modification of Embodiment of Thermal Head Driving Circuit

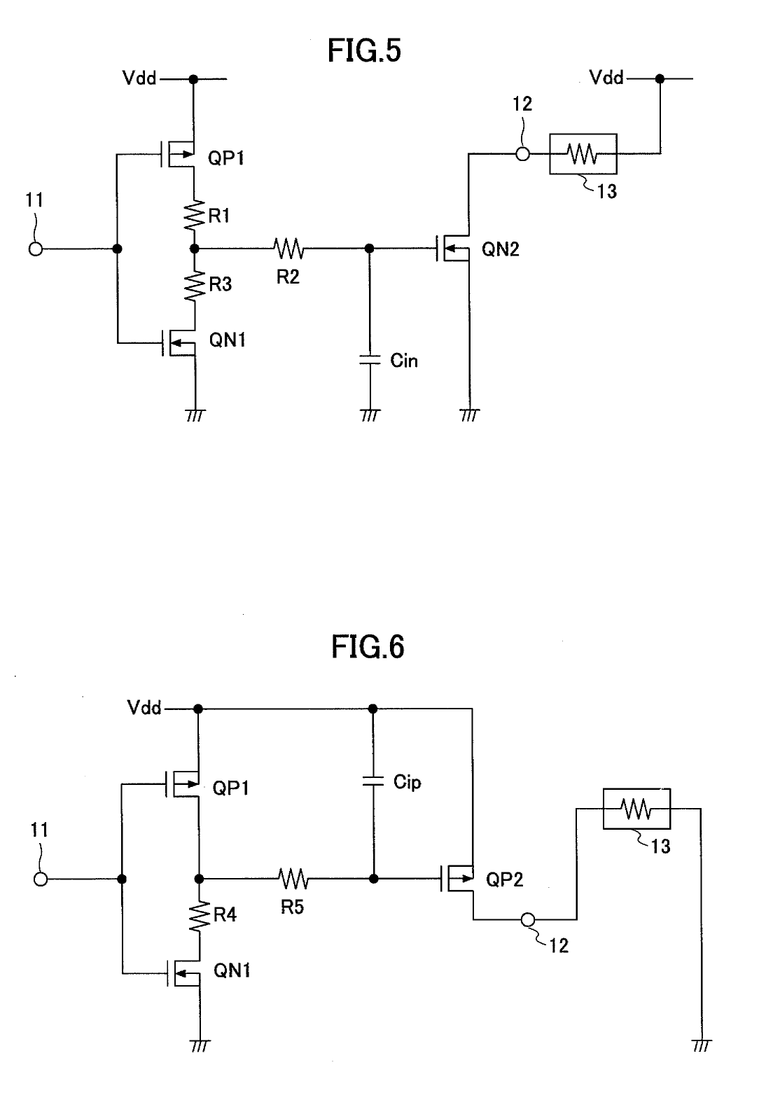

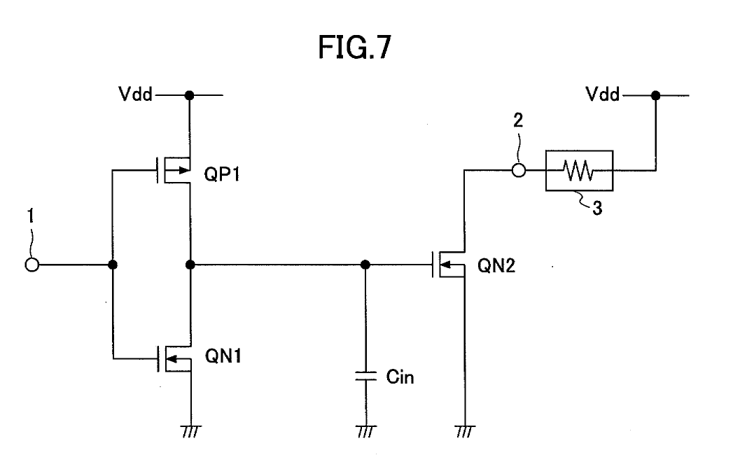

FIG. 5 is a circuit diagram of a modification of the thermal head driving circuit according to the embodiment of the present invention. This circuit is formed as a semiconductor integrated circuit, and the portion for driving one of the thermal heads is illustrated in FIG. 5.

As shown in FIG. 5, a one-bit driving signal (rectangular wave) is supplied to the terminal 11, which is then supplied to the gate of the p-channel MOS-FET QP1 and the n-channel MOS-FET QN1. The source of the FET QP1 is connected to the power source Vdd, the drain of the FET QP1 is connected to the drain of the FET QN1 via serially-connected resistances R1 and R3, the source of the FET QN1 is connected to ground, and the FET QP1 and the FET QN1 form an inverter type drive circuit.

The junction point of the resistance R1 and the resistance R3 is connected, via the resistance R2, to the gate of the n-channel FET QN2, which is a power MOS transistor. The FET QN2 has its source connected to ground and its drain connected to the external terminal 12 of the semiconductor integrated circuit. That is, the junction point of the resistance R1 and the resistance R2 is connected to the drain of the FET QN1 via the resistance R3.

The capacitor Cin provides a parasitic capacitance between the gate and the source of the FET QN2. One end of the thermal head 13 is connected to the external terminal 12, and the other end of the thermal head 13 is connected to the power source Vdd.

The electrical charge time constant of the capacitor Cin is determined by the capacitor Cin, which provides a parasitic capacitance between the gate and the source of the FET QN2, and the resistances R1 and R2, and the electrical discharge time constant of the capacitor Cin is determined by the capacitor Cin and the resistances R2 and R3.

In this modification, the switching noise at the times of the rise and the decay is reduced, and it is possible to prevent the semiconductor integrated circuit from breaking. Furthermore, the freedom in setting the resistance values of the resistances R1 through R3 is increased.

### Another Embodiment of Thermal Head Driving Circuit

FIG. 6 is a circuit diagram of the thermal head driving circuit according to another embodiment of the present invention. This circuit is formed as a semiconductor integrated circuit, and the portion for driving one of the thermal heads is illustrated in FIG. 6. In this embodiment, a p-channel MOS-FET is used as the power MOS transistor.

As shown in FIG. 6, a one-bit driving signal (rectangular wave) is supplied to the terminal 11, which is then supplied to the gates of a p-channel MOS-FET QP1 and the n-channel MOS-FET QN1. The source of the FET QP1 is connected to the power source Vdd, the drain of the FET QP1 is connected to the drain of the FET QN1 via a resistance R4, the source of the FET QN1 is connected to ground, and the FET QP1 and the FET QN1 form an inverter type drive circuit.

The junction point of the resistance R4 and the drain of the FET QP1 is connected, via a resistance R5, to the gate of the p-channel FET QP2, which is a power MOS transistor. The FET QP2 has its source connected to the power source Vdd and its drain connected to the external terminal 12 of the semiconductor integrated circuit.

A capacitor Cip provides a parasitic capacitance between the gate and the source of the FET QP2. One end of the thermal head 13 is connected to the external terminal 12, and the other end of the thermal head 13 is connected to ground.

The electrical charge time constant of the capacitor Cip is determined by the capacitor Cip, which provides a parasitic capacitance between the gate and the source of the FET QN2, and the resistance R5, and the electrical discharge time constant of the capacitor Cip is determined by the capacitor Cip and the resistances R4 and R5.

In this embodiment, the switching noise at the times of the rise and the decay is reduced, and it is possible to prevent the semiconductor integrated circuit from breaking.

It is also possible to add a resistance R6 to the circuit shown in FIG. 6 in the same manner as that shown in FIG. 5. In this case, the drain of the FET QP1 is connected to the drain of the FET QN1 via serially-connected resistances R6 and R4, and the junction point of the resistances R6 and R4 is connected to the gate of the FET QP2 via the resistance 5.

According to one embodiment of the present invention, a thermal head driving circuit includes an inverter type drive circuit including a p-channel MOS transistor (QP1) and a first n-channel MOS transistor (QN1), and configured to have a driving signal of a rectangular wave provided at gates of the p-channel MOS transistor (QP1) and the first n-channel MOS transistor (QN1) to invert the driving signal; a power MOS transistor (QN2) configured to have provided, at its gate, the inverted drive signal output from the inverter type drive circuit to drive a thermal head (13) connected to its drain; a first resistance (R1) connected between a drain of the p-channel MOS transistor (QP1) and a drain of the first n-channel MOS transistor (QN1); and a second resistance (R2) connected between a junction point between the first resistance (R1) and the drain of the first n-channel MOS transistor (QN1), and the gate of the power MOS transistor (QN2). Accordingly, the rise and the decay of the driving signal can be dampened to the same extent so that the switching noise is reduced and the semiconductor integrated circuit is prevented from breaking.

Additionally, the thermal head driving circuit includes a third resistance (R3) connected between a junction point between the first resistance (R1) and the second resistance (R2), and the drain of the first n-channel MOS transistor (QN1).

Additionally, in the thermal head driving circuit, the power MOS transistor (QN2) includes a second n-channel MOS transistor.

According to one embodiment of the present invention, a thermal head driving circuit includes an inverter type drive circuit including a first p-channel MOS transistor (QP1) and an n-channel MOS transistor (QN1), and configured to have a driving signal of a rectangular wave provided at gates of the first p-channel MOS transistor (QP1) and the n-channel MOS transistor (QN1) to invert the driving signal; a power MOS transistor (QN2) configured to have provided, at its gate, the inverted drive signal output from the inverter type drive circuit to drive a thermal head (13) connected to its drain; a first resistance (R1) connected between a drain of the first p-channel MOS transistor (QP1) and a drain of the n-channel MOS transistor (QN1); and a second resistance (R2) connected between a junction point between the first resistance (R1) and the drain of the first p-channel MOS transistor (QP1), and the gate of the power MOS transistor (QN2). Accordingly, the rise and the decay of the driving signal can be dampened to the same extent so that the switching noise is reduced and the semiconductor integrated circuit is prevented from breaking.

Additionally, in the thermal head driving circuit, the power MOS transistor (QN2) includes a second p-channel MOS transistor.

It is noted that the reference numerals in parentheses are given merely as examples to facilitate understanding, and the present invention should not be limited to the examples illustrated in the figures.

The present invention is not limited to the specifically disclosed embodiment, and variations and modifications may be made without departing from the scope of the present invention.

The present application is based on Japanese Priority Patent Application No. 2006-023601, filed on Jan. 31, 2006, the entire contents of which are hereby incorporated by reference.

What is claimed is:

1. A thermal head driving circuit comprising:
an inverter type drive circuit comprising a p-channel MOS transistor and a first n-channel MOS transistor, the inverter type drive circuit being configured to have a driving signal of a rectangular wave provided at gates of the p-channel MOS transistor and the first n-channel MOS transistor to invert the driving signal;
a power MOS transistor configured to have provided, at its gate, the inverted drive signal output from the inverter type drive circuit to drive a thermal head connected to its drain;
a first resistance connected between a drain of the p-channel MOS transistor and a drain of the first n-channel MOS transistor; and
a second resistance connected between a junction point between the first resistance and the drain of the first n-channel MOS transistor, and the gate of the power MOS transistor.

2. The thermal head driving circuit according to claim 1, further comprising:
a third resistance connected between a junction point between the first resistance and the second resistance, and the drain of the first n-channel MOS transistor.

3. The thermal head driving circuit according to claim 1, wherein:
the power MOS transistor comprises a second n-channel MOS transistor.

4. A thermal head driving circuit comprising:
an inverter type drive circuit comprising a first p-channel MOS transistor and an n-channel MOS transistor, the inverter type drive circuit being configured to have a driving signal of a rectangular wave provided at gates of the first p-channel MOS transistor and the n-channel MOS transistor to invert the driving signal;
a power MOS transistor configured to have provided, at its gate, the inverted drive signal output from the inverter type drive circuit to drive a thermal head connected to its drain;
a first resistance connected between a drain of the first p-channel MOS transistor and a drain of the n-channel MOS transistor; and
a second resistance connected between a junction point between the first resistance and the drain of the first p-channel MOS transistor, and the gate of the power MOS transistor.

5. The thermal head driving circuit according to claim 4, wherein:
the power MOS transistor comprises a second p-channel MOS transistor.
